(19) United States
(12) Patent Application Publication
(10) Pub. No.: US 2009/0041062 A1
(43) Pub. Date: Feb. 12, 2009

(54) FIBER-BASED TUNABLE LASER

(76) Inventor: Jian Liu, Sunnyvale, CA (US)

Correspondence Address: XIN WEN, 3449 RAMBOW DRIVE, PALO ALTO, CA, 94306, US

(21) Appl. No.: 12/100,669

(22) Filed: Apr. 10, 2008

Related U.S. Application Data
(60) Provisional application No. 60/922,939, filed on Apr. 11, 2007.

(51) Int. Cl. H01S 3/10; H01S 3/30

(52) U.S. Cl. 372/6; 372/20

(57) ABSTRACT

A fiber-based tunable laser includes a spectrum-expansion device comprising a micro structured fiber configured to receive a pump laser pulse having a first band width and a first pulse energy, and to produce a spectrally expanded laser pulse having a second band width at least two times broader than the first band width. The fiber-based tunable laser also includes a combiner that can couple the pump laser pulse into the spectrum-expansion device and a filter that can select a signal laser wavelength within the second band width and to produce a signal laser pulse at the signal laser wavelength. The signal laser pulse has a third band width narrower than the second band width. One or more cavity fibers allow propagation of the spectrally expanded laser pulse and the signal laser pulse between the spectrum-expansion device and the filter.

### BACKGROUND

The present invention relates to tunable laser systems.

Different approaches have existed in constructing tunable laser. For example, tunable lasers can be built nonlinear crystals that functions as an optical parametric oscillator (OPO). The nonlinear crystals can, for example, include periodically poled LiNbO₃ (PPLN). This type of solid-state tunable lasers is bulky and requires high level of maintenance, which limit their applications. Fiber-based tunable laser can be implemented using optical fibers doped with rare-earth elements as gain media. However, the tuning range of the conventional fiber laser is limited by the doping ion's gain properties. There is therefore a need for a compact and wide range wavelength tunable laser system which is also easy to maintain.

### SUMMARY

In a general aspect, the present invention relates to a fiber-based tunable laser includes a spectrum-expansion device comprising a micro structured fiber configured to receive a pump laser pulse having a first band width and a first pulse energy and to produce a spectrally expanded laser pulse having a second band width at least two times broader than the first band width. The fiber-based tunable laser also includes a combiner that can couple the pump laser pulse into the spectrum-expansion device, and a filter that can select a signal laser wavelength within the second band width and to produce a signal laser pulse at the signal laser wavelength. The signal laser pulse has a third band width narrower than the second band width. One or more cavity fibers allow propagation of the spectrally expanded laser pulse and the signal laser pulse between the spectrum-expansion device and the filter.

In another general aspect, the present invention relates to a fiber-based tunable laser that includes a spectrum-expansion device comprising a micro structured fiber configured to receive a first pump laser pulse having a first pulse energy and a first band width and to produce a first spectrally expanded laser pulse having a first spectrally expanded band width broader than the first band width, wherein the micro structured fiber configured to receive a second pump laser pulse having a second pulse energy and a second band width and to produce a second spectrally expanded laser pulse having a second spectrally expanded band width broader than the second band width, wherein the second pulse energy is higher than the first pulse energy, wherein the second spectrally expanded band width is broader than the second band width. The fiber-based tunable laser also includes a combiner that can couple the pump laser pulse into the spectrum-expansion device; a filter that can select a signal laser wavelength within the first spectrally expanded band width or the second spectrally expanded band width, thereby producing a signal laser pulse at the signal laser wavelength; and one or more cavity fibers that can allow propagation of the first spectrally expanded laser pulse, the second spectrally expanded laser pulse, and the signal laser pulse between the spectrum-expansion device and the filter.

In another general aspect, the present invention relates to a fiber-based tunable laser that includes a spectrum-expansion device comprising a micro structured fiber configured to receive a pump laser beam having a first band width and to produce a spectrally expanded laser beam having a second band width at least two times broader than the first band width; a combiner configured to couple the pump laser beam into the spectrum-expansion device; a filter that can select a signal laser wavelength within the second band width and to produce a signal laser beam at the signal laser wavelength, wherein the signal laser beam has a third band width less than half of the second band width; and one or more cavity fibers that can allow propagation of the spectrally expanded laser beam and the signal laser beam between the spectrum-expansion device and the filter.

Implementations of the system may include one or more of the following. The first band width can be narrower than 200 nm. The second band width can be wider than 30 nm. The first pulse energy can be in a range of about 1 nJ to about 10 nJ, wherein the second band width can be wider than 30 nm. The first pulse energy can be higher than 10 nJ, wherein the second band width can be wider than 500 nm. The second band width can be at least five times broader than the first band width. The third band width can be narrower than one tenth of the second band width. The signal laser pulse can have a pulse width shorter than one nanosecond. The pulse width can be shorter than one picosecond. The second band width can extend beyond the first band width in both longer wavelength and shorter wavelength directions. The micro structured fiber can be not doped with a rare earth element. The micro structured fiber can be selected from a group consisting of photonic crystal fiber (PCF), photonic-bandgap fiber, holey fiber, hole-assisted fiber, and Bragg fiber. The PCF can include a solid core and air holes positioned outside a solid core. The air holes in the micro structured fiber can be positioned periodically in a cross section of the micro structured fiber. The combiner can be formed by one or more fiber-based components. The fiber-based tunable laser can further include an output coupler configured to output at least a portion of the signal laser pulse out of the one of more cavity fibers. The fiber-based tunable laser can further include an isolator coupled to the one or more cavity fibers and to allow the signal laser pulse and the spectrally expanded laser pulse to propagate in a single direction. The spectrum-expansion device, the combiner, the filter, the isolator, and one or more cavity fibers can define a ring shaped laser resonance cavity. The one or more cavity fibers can include two reflective surfaces at the ends of one or more cavity fibers. The spectrum-expansion device, the combiner, the filter, and one or more cavity fibers can define a linear laser resonance cavity between the two reflective surfaces. The third band width can be narrower than 10 nm. The signal laser wavelength can be tunable from about 450 nm to about 2500 nm. Embodiments may include one or more of the following advantages. The described fiber-based tunable laser systems are integrated fiber based laser systems that can be more compact than some conventional laser systems, which allow the described fiber-based tunable laser systems to be used in a wider range of applications. The described fiber-based tunable laser systems are also much easier to maintain than conventional tunable laser systems. Furthermore, the described fiber-based tunable laser systems also provide a wider tunable range than some conventions systems.

### BRIEF DESCRIPTION OF THE DRAWINGS

The following drawings, which are incorporated in and from a part of the specification, illustrate embodiments of the present specification and, together with the description, serve to explain the principles of the specification.

FIG. 1 is a schematic diagram of a fiber-based laser system having a ring-shaped laser resonance cavity.

FIGS. 2A and 2B illustrate exemplified fiber-based combiners compatible with the Fiber-based tunable laser systems in FIGS. 1 and 2.

FIGS. 3-4 illustrate exemplified combiners compatible with the fiber-based tunable laser systems in FIGS. 1 and 2.

FIGS. 5A and 5B illustrate exemplified spectrum expansion of a pump laser beam by the spectral expansion device in the fiber-based tunable laser systems in FIGS. 1 and 2.

FIG. 6 is a schematic diagram of a fiber-based laser system having a linear laser resonance cavity.

FIG. 7 illustrates an exemplified detailed arrangement for a fiber mirror in the linear laser resonance cavity of the fiber-based tunable laser system in FIG. 6.

### DETAILED DESCRIPTION

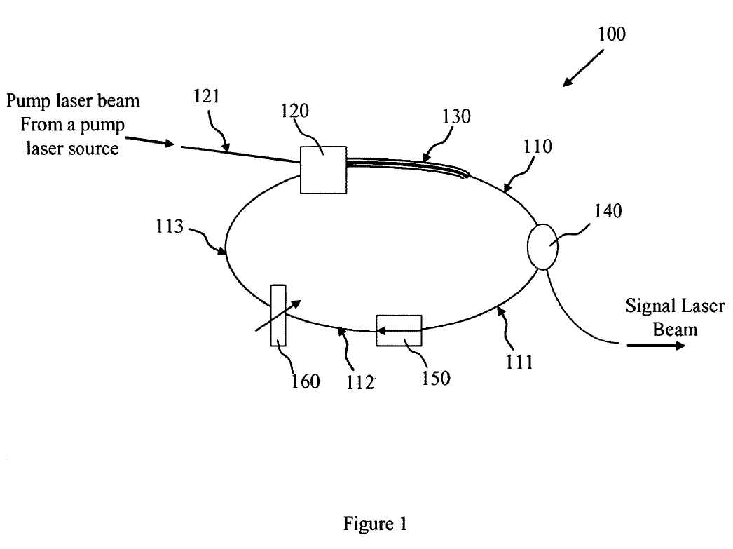

Referring to FIG. 1, a fiber-based tunable laser system 100 includes cavity fibers 110-113 that in part form a ring-shaped laser resonance cavity. The fibers 110-113 can be single mode fibers. The cavity optical fibers 110-113 are configured to transmit laser beams between several optical components including: a combiner 120 optically coupled to a fiber 121; a spectrum-expansion device 130 optically coupled to the combiner 120, an output coupler 140, an isolator 150, and a filter 160. The spectrum-expansion device 130 can be optically coupled to the combiner 120 by fusion splicing, or via free space optics. The positions of the output coupler 140, the isolator 150, and the filter 160 relative to the combiner 120 and the spectrum-expansion device 130 can vary along the ring-shaped laser resonance cavity formed by the cavity fibers 110-113.

The combiner 120 can receive, via the fiber 121, a pump laser beam from a pump laser source. The laser beam can be in the form of a continuous wave (CW) or laser pulses having pulse widths ranging from femtoseconds to 500 nanoseconds. An exemplified lasing wavelength range for the pump laser beam is from UV (150 nm) to mid IR (14 μm). The combiner 120 is a compact integrated device, which can be implemented in different approaches.

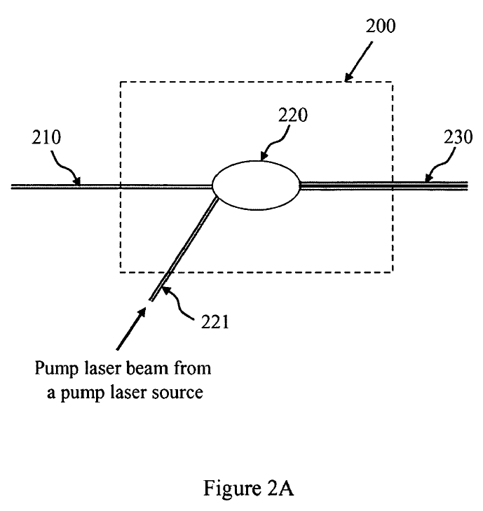

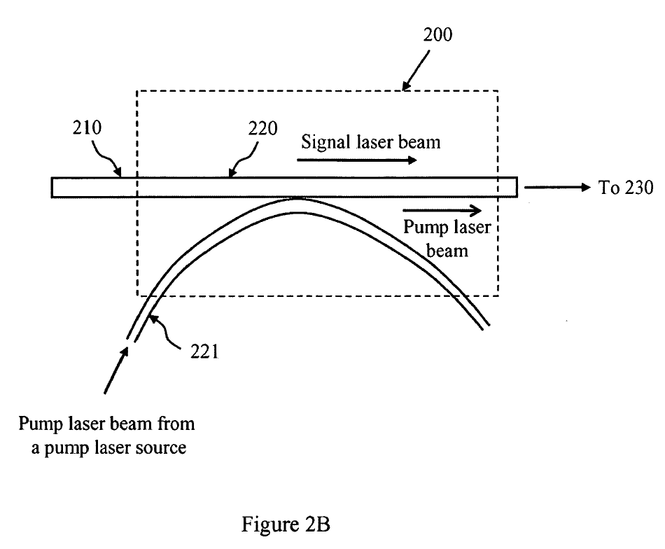

Referring to FIGS. 2A and 2B, a combiner 200 compatible with the fiber-based tunable laser system 100 includes a fiber coupler 220 that is optically coupled to a cavity fiber 210 and a spectrum-expansion device 230. The cavity fiber 210 and the spectrum-expansion device 230 can form part of a ring-shaped laser resonance cavity as described above. A fiber 221 coupled to the fiber coupler 220 can guide a pump laser beam into the fiber coupler 220. The fiber coupler 220 can be a section of a fiber that is fused to the fiber 221 or coupled to the fiber 221 via side polished surfaces. The fiber coupler 220 is capable of directing the pump laser beam from a pump laser source into the spectrum-expansion device 230. The fiber coupler 220 is also configured to allow a signal laser beam to pass through from the cavity fiber 210 to the spectrum-expansion device 230 (and vice versa). The signal laser beam, as described below, is amplified by the spectrum-expansion device 130 and can be tuned by the filter 160 to have a lasing wavelength different from that of the pump laser beam.

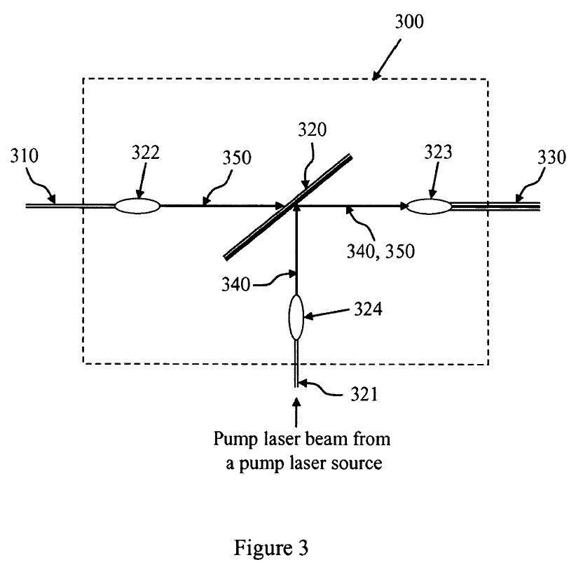

Referring to FIG. 3, a combiner 300 compatible with the fiber-based tunable laser system 100 includes a notch filter 320 that is optically coupled to a cavity fiber 310 and a spectrum-expansion device 330. The cavity fiber 310 and the spectrum-expansion device 330 can form part of a ring-shaped laser resonance cavity (shown in FIG. 1). A fiber 321 having a fiber lens 324 can guide a pump laser beam 340 through fiber lens 324 toward the notch filter 320. The notch filter 320 can reflect the pump laser beam 340 into a fiber lens 323 which in turn couples the input beam 340 into the spectrum-expansion device 330. The notch filter 320 can also receive a signal laser beam 350 from a fiber lens 322 coupled to the cavity fiber 310 and pass the signal laser beam 350 to the spectrum-expansion device 330. The lasing wavelength of the signal laser beam 350, as described below, can be tuned by the filter 160 and can be different from that of the pump laser beam 340. The surfaces of the notch filter 320 are coated with appropriate interference thin films to reflect substantially all the pump laser beam 340 at its lasing wavelength to the fiber lens 323, and pass the laser beam 350 at the lasing wavelength of the laser beam 350 from the fiber lens 322 to the fiber lens 323.

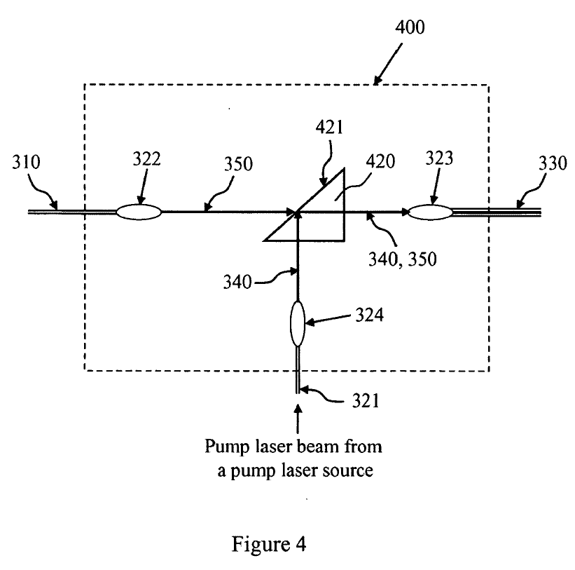

Similar to the combiner 300, another exemplified combiner 400 is shown in FIG. 4 with the notch filter 320 replaced by a total internal reflection (TIR) prism 420. The TIR prism 420 includes a surface 421 that can reflect, by total internal reflection, the pump laser beam 340 toward the fiber lens 323 coupled to the spectrum-expansion device 330. The TIR prism 420 can also pass a signal laser beam 350 received from the cavity fiber 310 to the spectrum-expansion device 330.

Referring back to FIG. 1, the pump laser source can emit a pump laser beam at from UV (150 nm) to mid IR (14 μm). For example, fiber-based pump laser can emit pump laser beams at 1550 nm band (1530-1610 nm) or 1 micron meter band (1020-1100 nm). The pump laser beam can be CW or include pulses having pulses width in a range from femto seconds to 500 nano seconds. The pump laser beam can have a spectral line width about 0.001 pm (a line width of about 1 kHz) to 10 nm for CW laser beams. The spectral bandwidth is about 0.1 nm to about 300 nm for pulsed pump laser beams having pulses widths in from 1 femtosecond to 500 nanoseconds.

The spectrum-expansion device 130 is a fiber based device. The spectrum-expansion device 130 can include a micro structured fiber. The micro structured fiber is a passive device that does not receive external power. The micro structured fiber is not intentionally doped by rare earth elements as in some conventional tunable laser systems. Examples of micro structured fiber compatible with the described fiber-based tunable laser systems include photonic crystal fiber (PCF), photonic-bandgap fiber, holey fiber (having air holes in their cross-sections), hole-assisted fiber (having a higher-index solid core modified by the presence of air holes), and Bragg fiber (photonic-bandgap fiber formed by concentric ring structures). The micro structured fiber can include periodically or non-periodically distributed air holes in the cross section of a fiber. The air holes can be positioned as a cladding outside a solid or a hollow core.

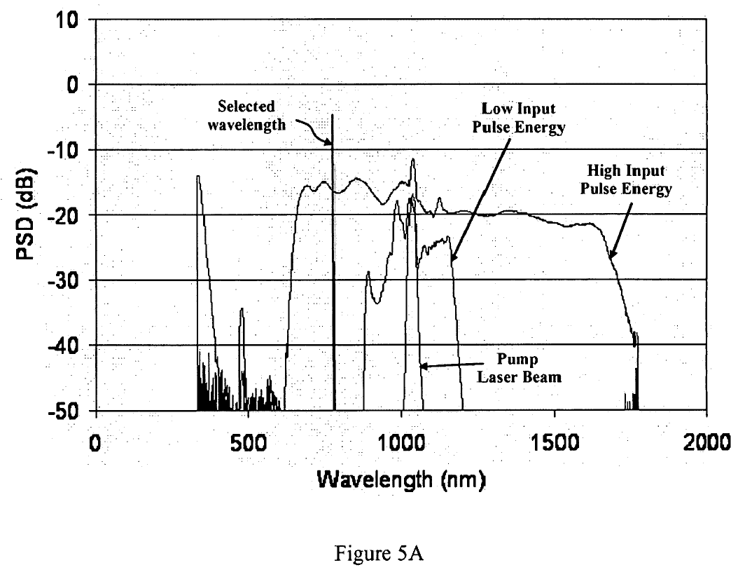

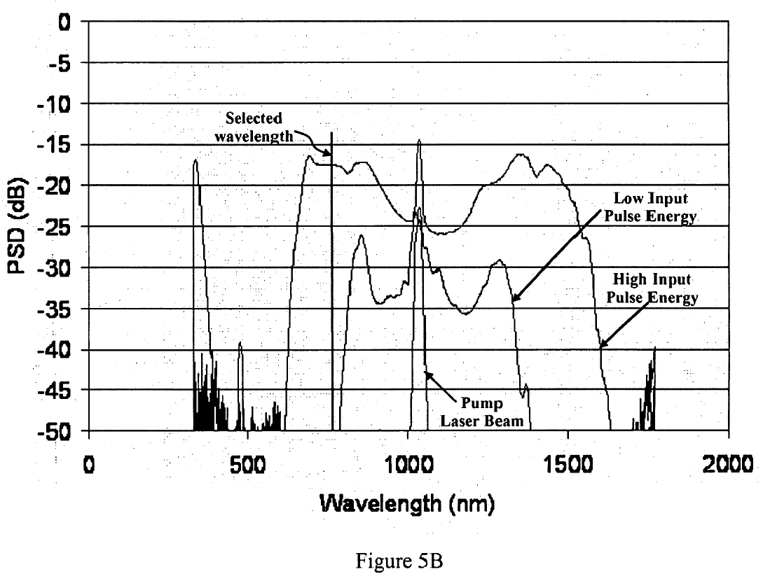

In one aspect, the spectrum-expansion device 130 can significantly expand the spectral band width of the pump laser beam (i.e. “spectral expansion”). For example, the pump laser beam can have a spectral bandwidth of about 10 nm around a center wavelength of about 1030 nm (i.e. pump laser wavelength) and a pulse width of 300 fs. Referring to FIG. 5A, the spectrum-expansion device 130 based on a micro structured fiber can produce a spectrally expanded laser beam having a spectral bandwidth broader than 200 nm, or for example, in the range of about 450 nm and about 2500 nm in response to the pump laser beam. (It should be noted that detection range of the spectral analyzer used to generate the curves in FIGS. 5A and 5B is limited between 700 nm and 1700 nm. The “high input pulse energy” curve actually has a wider bandwidth than what is shown in FIGS. 5A and 5B.)

The tunable spectral ranges of the described fiber-based tunable lasers are much wider than some conventional fiber-based tunable laser systems. For example, conventional Yb doped lasers can be tuned from 1020 nm to 1100 nm; Er doped fiber laser can be tuned in a range of 1520 nm and 1610 nm, which is much narrower the tunable spectral ranges of the described fiber-based tunable lasers.

An advantageous feature of the disclosed fiber-based tunable laser is that the extent of the spectral expansion is dependent on the power of the pump laser beam. For example, for pump laser pulses having energy about 5 nJ and a spectral band width of about 10 nm at a center wavelength of 1030 nm, the spectrally expanded laser beam can have a 3 dB spectral bandwidth about 50 nm at the center wavelength of 1030 nm (shown by the curve labeled as “low input pulse energy” in FIG. 5A). For pump laser pulses having energy about 20 nJ and a spectral band width of about 10 nm at a center wavelength of 1030 nm, the spectrally expanded laser beam can have a 3 dB spectral bandwidth about 2000 nm at the center wavelength of 1030 nm (shown by the curve labeled as “high input pulse energy” in FIG. 5A). FIG. 5B illustrates the expansion of spectral bandwidth of the pump laser beam by a spectrum-expansion device based on another micro structured fiber. The spectral expansion of the disclosed fiber-based tunable laser is applicable to pump laser pulses having energies higher than 20 nJ, such as 100 nJ, 1 μJ, 10 μJ, and 100 μJ. The spectral line width of the pump laser beam can vary as a function of the pulse energy of the pump laser pulse, for example from 0.001 pm to 25 nm. The spectral bandwidth of a pump laser pulse at each fixed pulse energy can be expanded by a factor of higher than 1, a factor of 2 or more, a factor of 5 or more, or a factor of 10 or more.

The spectral distribution of the pump laser beam can be expanded by the spectrum-expansion device 130 in the longer wavelength and the shorter wavelength directions. As a result, the spectral bandwidth of the pump laser beam is positioned within the spectral bandwidth (which can be referred as “super continuum” spectrum in the present specification) of the spectrally expanded laser beam, as shown FIGS. 5A and 5B.

Referring back to FIG. 1 the spectrally expanded laser beam exiting the spectrum-expansion device 130 propagates along the cavity fiber 110, through the output coupler 140, then through the cavity fiber 111 to the isolator 150. The isolator 150 passes the spectrally expanded laser beam in a uni-direction as indicated by the arrow (in the isolator) and suppress reflections in the reverse direction in the ring-shaped laser resonance cavity. The cavity fiber 112 then guides the spectrally expanded laser beam to a filter 160 which can be tuned to select a signal lasing wavelength for the signal laser beam in the expanded spectrum of the spectrally expanded laser beam. For example, as shown in FIGS. 5A and 5B, the selected signal lasing wavelength can be selected to be at about 750 nm (i.e. signal laser wavelength) for a pump laser beam comprising high input pulse energy. The filter 160 can include a thin film coated on the surface of a transparent optical media. The wavelength tuning can be realized by changing the incident angle of the spectrally expanded laser beam relative to the surface by rotating the optical media by a transport mechanism. The filter 160 can also be implemented by an acoustic grating actuated by an alternating electric field in an acoustic optical media. The alternating electric field can be produced by appropriate electrodes in contact with the acoustic optical media. The period of the grating can be varied by changing the frequency of the electric wave in the acoustic optical media.

The portion of the spectrally expanded laser beam inside the band width of the signal laser beam can pass through the filter 160 and the spectrum-expansion device 130, and is enhanced by resonates in the ring-shaped laser resonance cavity to form a signal laser beam having a signal band width in a range of 0.001 pm (or a line width of about 1 KHz) and 200 nm. In some embodiments, the signal band width is narrower than half, a quarter, or one tenth of the expanded spectrum. The portion of the spectrally expanded laser beam outside the signal band width is suppressed. The output coupler 140 can output at least a portion of the signal laser beam out of the ring-shaped resonance cavity. The signal lasing wavelength can be tuned continuously to a wavelength shorter or longer than the pump laser wavelength within the expanded spectrum.

In some embodiments, the signal laser beam (CW or pulsed) in the described fiber-based tunable lasers can be tuned over an expanded spectrum from about 450 nm to about 2500 nm, which can be achieved by the controlling wavelength selection by the filter 160 and dispersion management. In a CW operation, the signal spectral bandwidth can be in a range from 1 kHz (line width) to 10 nm. In a pulsed operation, the signal laser beam can have a pulse width ranging from 1 fs to 500 ns and a spectral bandwidth ranging from about 0.1 nm to about 300 nm.

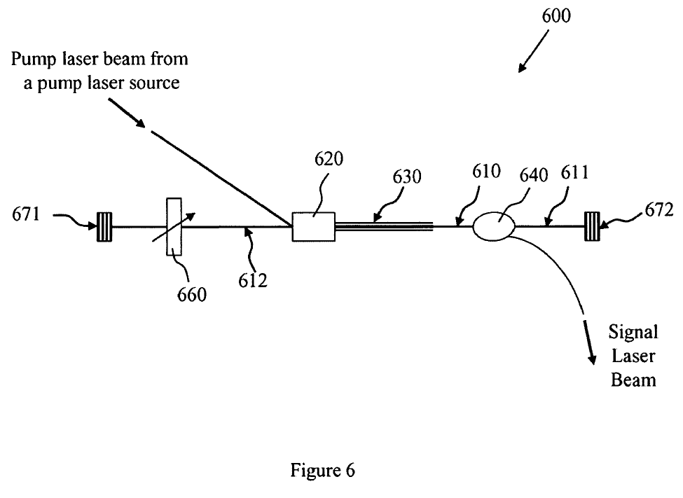

In some embodiments, referring to FIG. 6, a fiber-based laser system 600 includes cavity fibers 610-612. The end faces of the cavity fibers 611-612 are respectively coated with reflective layers to form mirrors 671 and 672. The fibers 610-612 can be single mode fibers. The cavity fibers 611-612 and other components as described next define a linear laser resonance cavity between the mirrors 671 and 672. The cavity fibers 610-612 are configured to transmit laser beams between several optical components including: a combiner 620 optically coupled to a fiber 621; a spectrum-expansion device 630 optically coupled to the combiner 620, an output coupler 640, and a filter 660. The spectrum-expansion device 630 can be optically coupled to the combiner 620 by fusion splicing, or via a free space. The positions of the output coupler 640 and the filter 660 relative to the combiner 620 and the spectrum-expansion device 630 can vary along the linear laser resonance cavity formed by the cavity fibers 610-612. The combiner 620 can receive, via the fiber 621, a pump laser beam from a pump laser source.

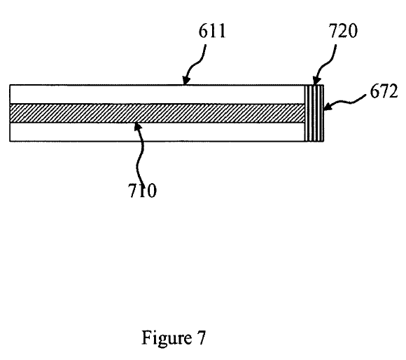

An exemplified detailed arrangement for a fiber mirror 671 or 672 in the fiber-based tunable laser system 600 is shown in FIG. 7. The cavity fiber 611 can include a solid core 710 for guiding the propagation of a spectrally expanded laser beam or a signal laser beam. The end face 720 of the cavity fiber 611 is coated with one or more layer of thin films that can reflect the spectrally expanded laser beam or a signal laser beam in a broadband.

Similar to the description above relating to fiber-based laser system 100, the laser beam can be in the form of a continuous wave (CW) or laser pulses having pulse widths ranging from femto seconds to 500 nanoseconds. An exemplified lasing wavelength range for the pump laser beam is from UV (150 nm) to mid IR (14 μm). In some embodiments, the combiner 620 is an integrated wavelength-division multiplexing (WDM) device that can direct the pump laser beam at a first wavelength and a signal laser beam from the cavity fiber 612 to the spectrum-expansion device 630.

The functions of the spectrum-expansion device 630, the combiner 620, the output coupler 640, and the filter 660 are similar to the descriptions above in relation to the spectrum-expansion device 130, the combiner 120, the output coupler 140, and the filter 160. The spectrum-expansion device 630 can be, for example, a micro structured optical fiber. The spectrum-expansion device 630 does not need to be doped by rare earth elements as in some conventional tunable laser systems. Examples of micro structured fiber compatible with the described fiber-based tunable laser systems include photonic crystal fiber (PCF), photonic-bandgap fiber, holey fiber (having air holes in their cross-sections), hole-assisted fiber (having a higher-index solid core modified by the presence of air holes), and Bragg fiber (photonic-bandgap fiber formed by concentric ring structures). The micro structured fiber can include periodically or non-periodically distributed air holes in the cross section of a fiber. The air holes can be positioned as a cladding outside a solid or a hollow core.

The extent of the spectral extension is dependent on and can be adjusted by the energy of the pump laser pulses. The pump laser beam having narrow band width at a pump laser wavelength can be tuned by the fiber-based tunable laser 600 to produce a signal laser beam at the signal wavelength a shown in FIGS. 5A and 5B. The signal lasing wavelength can be tuned continuously to a wavelength shorter or longer than the pump laser wavelength within the expanded spectrum.

An advantage of the may include one or more of the following advantages. The described fiber-based tunable laser systems are integrated fiber based laser systems that can be more compact than some conventional laser systems, which allow the described fiber-based tunable laser systems to be used in a wider range of applications. The described fiber-based tunable laser systems are also much easier to maintain than conventional fiber-based tunable laser systems. Furthermore, the described fiber-based tunable laser systems also provide a wider tunable range than some conventions systems.

It is understood the disclosed systems and methods are compatible with other variations. The disclosed tunable laser system is applicable to continuous wave pump laser beams or laser pulses and can produce continuous wave signal laser beams or signal laser pulses. For example, the spectrum-expansion device in the described fiber-based tunable lasers can include high nonlinear fibers such as silica and Chalcogenide fiber, Raman fiber, periodic poled fiber, periodic poled Lithium Niobate such as LiNbO₃ crystal waveguide. In another example, the filter for selecting the signal laser wavelength in the described fiber-based tunable lasers can be fixed at a pre-determined frequency or tunable in a range within the expanded spectrum. In some aspect, the spectrum-expansion device in the described fiber-based tunable lasers can function as an optical parametric oscillator (OPO) to expand the spectral distributions of a continuous or pulsed pump laser beam.

What is claimed is:

1. A fiber-based tunable laser, comprising:
a spectrum-expansion device comprising a micro structured fiber configured to receive a pump laser pulse having a first band width and a first pulse energy, and to produce a spectrally expanded laser pulse having a second band width at least two times broader than the first band width;
a combiner configured to couple the pump laser pulse into the spectrum-expansion device;
a filter configured to select a signal laser wavelength within the second band width and to produce a signal laser pulse at the signal laser wavelength, wherein the signal laser pulse has a third band width narrower than the second band width; and
one or more cavity fibers configured to allow propagation of the spectrally expanded laser pulse and the signal laser pulse between the spectrum-expansion device and the filter.

2. The fiber-based tunable laser of claim 1, wherein the second band width is wider than 30 nm.

3. The fiber-based tunable laser of claim 1, wherein the first pulse energy is in a range of about 1 nJ to about 10 nJ, wherein the second band width is wider than 30 nm.

4. The fiber-based tunable laser of claim 1, wherein the first pulse energy is higher than 10 nJ, wherein the second band width is wider than 500 nm.

5. The fiber-based tunable laser of claim 1, wherein the second band width is at least five times broader than the first band width.

6. The fiber-based tunable laser of claim 1, wherein the third band width is narrower than one tenth of the second band width.

7. The fiber-based tunable laser of claim 1, wherein the third band width is narrower than 10 nm.

8. The fiber-based tunable laser of claim 1, wherein the signal laser pulse has a pulse width shorter than one nanosecond.

9. The fiber-based tunable laser of claim 8, wherein the pulse width is shorter than one picosecond.

10. The fiber-based tunable laser of claim 1, wherein the signal laser wavelength is tunable by the filter from about 450 nm to about 2500 nm.

11. The fiber-based tunable laser of claim 1, wherein the second band width extends beyond the first band width in both longer wavelength and shorter wavelength directions.

12. The fiber-based tunable laser of claim 1, wherein the micro structured fiber is not doped with a rare earth element.

13. The fiber-based tunable laser of claim 1, wherein the micro structured fiber is selected from a group consisting of photonic crystal fiber (PCF), photonic-bandgap fiber, holey fiber, hole-assisted fiber, and Bragg fiber.

14. The fiber-based tunable laser of claim 13, wherein the PCF includes a solid core and air holes positioned outside a solid core.

15. The fiber-based tunable laser of claim 12, wherein the air holes in the micro structured fiber are positioned periodically in a cross section of the micro structured fiber.

16. The fiber-based tunable laser of claim 1, further comprising an output coupler configured to output at least a portion of the signal laser pulse out of the one of more cavity fibers.

17. The fiber-based tunable laser of claim 1, further comprising an isolator coupled to the one or more cavity fibers and to allow the signal laser pulse and the spectrally expanded laser pulse to propagate in a single direction, wherein the spectrum-expansion device, the combiner, the filter, the isolator, and one or more cavity fibers are configured to define a ring shaped laser resonance cavity.

18. The fiber-based tunable laser of claim 1, wherein the one or more cavity fibers include two reflective surfaces at the ends of one or more cavity fibers, wherein the spectrum-expansion device, the combiner, the filter, and one or more cavity fibers are configured to define a linear laser resonance cavity between the two reflective surfaces.

19. A fiber-based tunable laser, comprising:
a spectrum-expansion device comprising a micro structured fiber configured to receive a first pump laser pulse having a first pulse energy and a first band width and to produce a first spectrally expanded laser pulse having a first spectrally expanded band width broader than the first band width, wherein the micro structured fiber configured to receive a second pump laser pulse having a second pulse energy and a second band width and to produce a second spectrally expanded laser pulse having a second spectrally expanded band width broader than the second band width, wherein the second pulse energy is higher than the first pulse energy, wherein the second spectrally expanded band width is broader than the second band width;
a combiner configured to couple the pump laser pulse into the spectrum-expansion device;
a filter configured to select a signal laser wavelength within the first spectrally expanded band width or the second spectrally expanded band width, thereby producing a signal laser pulse at the signal laser wavelength; and
one or more cavity fibers configured to allow propagation of the first spectrally expanded laser pulse, the second spectrally expanded laser pulse, and the signal laser pulse between the spectrum-expansion device and the filter.

20. The fiber-based tunable laser of claim 19, wherein the first spectrally expanded band width is at least five times broader than the first band width.

21. The fiber-based tunable laser of claim 19, wherein the signal laser pulse has a third band width less than one tenth of the first spectrally expanded band width.

22. The fiber-based tunable laser of claim 19, wherein the signal laser band width is narrower than 10 nm.

23. The fiber-based tunable laser of claim 19, wherein the signal laser wavelength is tunable by the filter from about 450 nm to about 2500 nm.

24. The fiber-based tunable laser of claim 19, wherein the first spectrally expanded band width and the second spectrally expanded band width are wider than 30 nm.

25. The fiber-based tunable laser of claim 19, wherein the first pulse energy is in a range of about 1 to about 10 nJ, wherein the first spectrally expanded band width is wider than 30 nm.

26. The fiber-based tunable laser of claim 19, wherein the second pulse energy is higher than 10 nJ, wherein the second spectrally expanded band width is wider than 500 nm.

27. The fiber-based tunable laser of claim 19, wherein the signal laser pulse has a pulse width shorter than one nanosecond.

28. The fiber-based tunable laser of claim 19, wherein the first spectrally expanded band width extends beyond the first band width in both longer wavelength and shorter wavelength directions.

29. The fiber-based tunable laser of claim 19, wherein the micro structured fiber is not doped with a rare earth element.

30. The fiber-based tunable laser of claim 19, wherein the micro structured fiber is selected from a group consisting of photonic crystal fiber (PCF), photonic-bandgap fiber, holey fiber, hole-assisted fiber, and Bragg fiber.

31. The fiber-based tunable laser of claim 19, further comprising an output coupler configured to output at least a portion of the signal laser pulse out of the one of more cavity fibers.

32. The fiber-based tunable laser of claim 19, further comprising an isolator coupled to the one or more cavity fibers and to allow the signal laser pulse, the first spectrally expanded laser pulse, and the second spectrally expanded laser pulse to propagate in a single direction, wherein the spectrum-expansion device, the combiner, the filter, the isolator, and one or more cavity fibers in part define a ring shaped laser resonance cavity.

33. The fiber-based tunable laser of claim 19, wherein the one or more cavity fibers include two reflective surfaces at the ends of one or more cavity fibers, wherein the spectrum-expansion device, the combiner, the filter, and one or more cavity fibers in part define a linear laser resonance cavity between the two reflective surfaces.

34. A fiber-based tunable laser, comprising:
a spectrum-expansion device comprising a micro structured fiber configured to receive a pump laser beam having a first band width and to produce a spectrally expanded laser beam having a second band width at least two times broader than the first band width;
a combiner configured to couple the pump laser beam into the spectrum-expansion device;
a filter configured to select a signal laser wavelength within the second band width and to produce a signal laser beam at the signal laser wavelength, wherein the signal laser beam has a third band width less than half of the second band width; and
one or more cavity fibers configured to allow propagation of the spectrally expanded laser beam and the signal laser beam between the spectrum-expansion device and the filter.

35. The fiber-based tunable laser of claim 34, wherein the signal laser beam is a continuous wave.

36. The fiber-based tunable laser of claim 35, wherein the third band width is less than 10 nm.

37. The fiber-based tunable laser of claim 34, wherein the signal laser beam comprises a signal laser pulse having a pulse width shorter than 500 nanoseconds.

38. The fiber-based tunable laser of claim 37, wherein the signal laser beam comprises a signal laser pulse having a pulse width shorter than one nanosecond.

39. The fiber-based tunable laser of claim 38, wherein the signal laser beam comprises a signal laser pulse having a pulse width shorter than one picosecond.

40. The fiber-based tunable laser of claim 34, wherein the signal laser wavelength is tunable by the filter from about 450 nm to about 2500 nm.
